(19) United States
(12) Patent Application Publication
(10) Pub. No.: US 2024/0063696 A1
(43) Pub. Date: Feb. 22, 2024

(54) Method for Producing a Stack of Magnetic Sheets for a Rotor and/or Stator of an Electric Machine, and Method for Producing an Electric Machine, and Method for Producing an Installation and a Vehicle

(71) Applicant: Siemens Aktiengesellschaft, München (DE)

(72) Inventors: Carsten Schuh, Baldham (DE); Thomas Soller, Deggendorf, Bayern (DE); Rolf Vollmer, Gersfeld (DE)

(73) Assignee: Siemens Aktiengesellschaft, München (DE)

(21) Appl. No.: 18/259,370

(22) PCT Filed: Dec. 21, 2021
(86) PCT No.: PCT/EP2021/086962

§ 371 Date: Jun. 26, 2023

(30) Foreign Application Priority Data
Dec. 30, 2020 (EP) 20217889.3

(51) Int. Cl. H02K 15/02

(52) U.S. Cl. CPC H02K 15/02; B33Y 80/00; H02K 2215/00

(57) ABSTRACT

Various embodiments include a method for manufacturing a stack of magnetic laminations for a rotor and/or stator of an electric machine. The method includes: recording a respective physical property of each respective magnetic lamination from a plurality of magnetic laminations; determining a setpoint value for a physical variable of the stack of magnetic laminations; ascertaining a stacking sequence of the individual magnetic laminations of the plurality reducing a deviation of an actual value for the physical variable of the stack with the ascertained stacking sequence from a setpoint value in relation to stacks with other stacking sequences of magnetic laminations; and stacking the plurality of the magnetic laminations in the ascertained stacking sequence.

### CROSS-REFERENCE TO RELATED APPLICATIONS

This application is a U.S. National Stage Application of International Application No. PCT/EP2021/086962 filed Dec. 21, 2021, which designates the United States of America, and claims priority to EP Application No. 20217889.3 filed Dec. 30, 2020, the contents of which are hereby incorporated by reference in their entirety.

### TECHNICAL FIELD

The present disclosure relates to electric machines. Various embodiments may include methods and/or systems for manufacturing a stack of magnetic laminations for a rotor and/or a stator of an electric machine.

### BACKGROUND

Some methods for producing magnetic laminations for electric machines include screen and/or stencil printing. In this respect, firstly a printing paste is created from metal powders and then it is processed by means of screen and/or stencil printing to form a green body, that is to say a thick layer. Subsequently, the green body is subjected to a thermal treatment, that is to say binder removal and sintering, and thus transformed into a metallic, structured magnetic lamination.

However, in the case of screen and stencil printing, troublesome manufacturing tolerances can easily arise in such a way that the operationally critical specifications required for the operation of an electric machine cannot be achieved. Such tolerances may for example relate to the geometric dimensions, the density or the microstructure and the surface finish. The chemical composition and the magnetic properties of the magnetic laminations can also be subject to disadvantageous variations in the case of screen and stencil printing.

### SUMMARY

Teachings of the present disclosure include improved methods and/or systems for manufacturing a stack of magnetic laminations for a rotor and/or a stator of an electric machine. In particular, the method should enable the manufacture of an electric machine having improved properties over those known in the prior art. For example, some embodiments include a method for manufacturing a stack (10) of magnetic laminations (20) for a rotor (500) and/or stator (510) of an electric machine (520), wherein a plurality of magnetic laminations (20) is used, a respective physical property of a respective magnetic lamination (20) of the plurality is recorded, a setpoint value for a physical variable of the stack (10) of magnetic laminations (20) is determined and such a stacking sequence of magnetic laminations (20) of the plurality is ascertained that reduces a deviation of an actual value for the physical variable of the stack (10) with the ascertained stacking sequence from at least one setpoint value in relation to stacks (10) with other stacking sequences of magnetic laminations (20) of the plurality, and the stack (10) is stacked in the ascertained stacking sequence.

In some embodiments, the magnetic laminations (20) of the plurality are manufactured by means of screen and/or stencil printing.

In some embodiments, the at least one physical property of a magnetic lamination (20) is or are one or more geometric dimensions of the magnetic lamination (20), in particular an outside and/or inside diameter of the magnetic lamination (20), and/or comprises one or more of the following physical properties: a density of the magnetic lamination (20) and/or a microstructure and/or a chemical composition and/or a topography and/or a heat conductivity and/or one or more mechanical internal stresses of the magnetic lamination (20) and/or one or more magnetic properties of the magnetic lamination (20), in particular a saturation field strength and/or a coercive field strength and/or a remanence and/or a hysteresis, preferably the profile of a hysteresis curve, of the magnetic lamination (20).

In some embodiments, the setpoint value for the physical variable comprises one or more geometric dimensions of the stack (10) of magnetic laminations (20) and/or one or more of the following physical variables: an overall density of the stack (10) and/or a variance in geometric dimensions of the stack (10), preferably transversely to the stacking direction (30), and/or one or more magnetic properties of the stack (10), in particular a magnetic saturation field strength and/or parameters of a hysteresis curve, preferably a coercive field strength and/or a remanence, of the stack (10).

In some embodiments, the stacking sequence is ascertained for a genuine subset of the plurality of magnetic laminations (20).

In some embodiments, the stacking sequence is ascertained by firstly determining at least two or more candidate stacking sequences for a stacking sequence and comparing actual values for the candidate stacking sequences with the setpoint value and ascertaining as stacking sequence that candidate stacking sequence that has an actual value deviating the least from the setpoint value.

In some embodiments, the stacking sequence is ascertained by means of artificial intelligence.

In some embodiments, a geometric shape of the stack is recorded and a geometric shape of a stacking aid (50), which makes it possible to stack the magnetic laminations (20) in the ascertained stacking sequence, is ascertained.

In some embodiments, adapting and/or exchanging elements for adapting the actual value to the setpoint value are provided and wherein the stacking sequence is ascertained taking into account the adapting and/or exchanging elements in such a way that a deviation of an actual value for the physical variable of the stack (10) with the ascertained stacking sequence from the at least one setpoint value is reduced by means of the adapting and/or exchanging elements.

In some embodiments, the adapting and/or exchanging elements are manufactured by means of additive manufacturing.

In some embodiments, the stacking aid (50) is manufactured by additive manufacturing processes and the stack is formed by means of the stacking aid.

In some embodiments, the magnetic laminations (20) are stacked and pressed together.

In some embodiments, the magnetic laminations (20) are alternately stacked and pressed together.

As another example, some embodiments include a method for manufacturing an electric machine (520), wherein a rotor (500) and/or stator (510) with a stack (10) of magnetic laminations (20) is formed, wherein the stack (10) of magnetic laminations (20) is manufactured by a method for manufacturing a stack (10) of magnetic laminations (20) as claimed in one of the preceding claims.

As another example, some embodiments include a method for manufacturing an installation (540) and/or a vehicle, wherein firstly an electric machine (520) is manufactured by a method for manufacturing an electric machine (520) as described herein and then the installation (540) or the vehicle is provided with the electric machine (520).

### BRIEF DESCRIPTION OF THE DRAWINGS

The teachings herein are explained in more detail below on the basis of an exemplary embodiment illustrated in the drawing, in which:

FIG. 1 shows a schematic cross section through a stack of magnetic laminations in one embodiment of a method incorporating teachings of the present disclosure for manufacturing a stack of magnetic laminations for a rotor and/or stator of an electric machine;

FIG. 2 shows a basic sketch of a schematic flow diagram of the method for manufacturing the stack of magnetic laminations according to FIG. 1;

FIG. 3 schematically shows a plan view of the stack of magnetic laminations according to FIG. 1; and

FIG. 4 schematically shows a basic sketch of an installation which is manufactured and has an electric machine having a rotor manufactured by the method from FIG. 2 and a stator manufactured by the method according to FIG. 2, having the stack of magnetic laminations from FIG. 1.

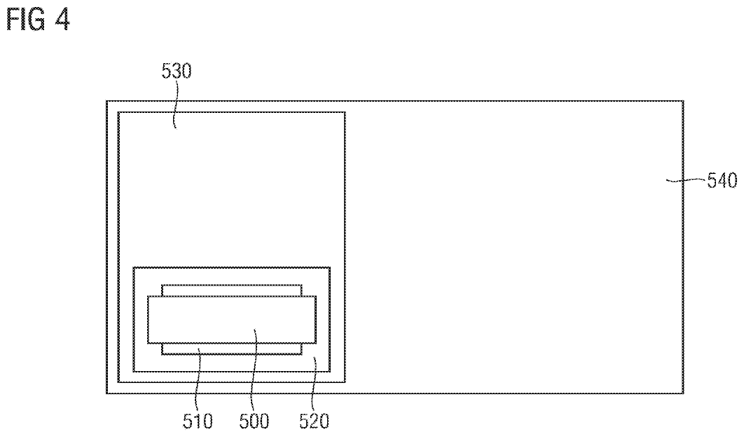

### DETAILED DESCRIPTION

In the methods incorporating teachings of the present disclosure for manufacturing a stack of magnetic laminations for a rotor and/or stator of an electric machine, a plurality of magnetic laminations is used and at least one respective physical property of a respective magnetic lamination of the plurality is recorded.

A setpoint value for a physical variable of the stack of magnetic laminations is determined and such a stacking sequence of magnetic laminations of the plurality is ascertained that reduces a deviation of an actual value for the physical variable of the stack with the ascertained stacking sequence from at least one setpoint value in relation to stacks with other stacking sequences of magnetic laminations of the plurality, and the stack is stacked in the ascertained stacking sequence.

By means of the teachings herein, it is possible to determine such a sequence of magnetic laminations that enables a stack with an actual value for the physical variable that comes particularly close to a setpoint value for the physical variable of the stack. In this way, operationally critical variables of the stack and thus also of an electric machine in which such a stack is installed in the form of a stator and/or rotor can be achieved, even though the individual magnetic laminations are subject to a manufacturing tolerance. In particular, it is thus also possible to use such manufacturing methods for magnetic laminations which, in known manufacturing methods, would not be able to be utilized in the manufacture of magnetic laminations for electric machines owing to their manufacturing tolerances. It is also possible to considerably reduce the occurrence of rejects, since magnetic laminations with attendant tolerances, which would have been counted as rejects in the case of known methods, can be used.

Consequently, the method described herein can be utilized with lower costs of mistakes and increased probability of achieving a necessary specification over the prior art.

Where the present application mentions a “stator and/or rotor of an electric machine”, this is to be understood to mean a “stator and/or rotor for an electric machine”, i.e. “suitable for use in an electric machine”.

It is self-evident that the term “magnetic lamination” within the meaning of the present disclosure also or in particular means or can mean printed and/or sintered parts. Within the context of the present disclosure, the term “magnetic lamination” can also be replaced by the phrase “material layer made from magnetic material” or “material layer structure made from magnetic material”, wherein the material layer or the material layer structure is preferably a flat part. That is to say, the term “magnetic lamination” in the present disclosure does not imply a necessary manufacturing step by means of rolling. Instead, “magnetic laminations” may be or have been manufactured by another manufacturing method.

In some embodiments, the magnetic laminations of the plurality are firstly manufactured by means of screen and/or stencil printing. Specifically in the case of screen and/or stencil printing of magnetic laminations for stators and/or rotors for electric machines, manufacturing tolerances frequently arise, with the result that specifically in this refinement the method according to the invention can be utilized easily and reliably.

In some embodiments, the at least one physical property of a magnetic lamination comprises one or more geometric dimensions of the magnetic lamination, in particular an outside and/or inside diameter of the magnetic lamination, and/or one or more of the following physical properties: a density of the magnetic lamination and/or a microstructure and/or a chemical composition and/or a topography and/or a heat conductivity and/or one or more mechanical internal stresses of the magnetic lamination and/or one or more magnetic properties of the magnetic lamination, in particular a saturation field strength and/or a coercive field strength and/or a remanence and/or a hysteresis, preferably the profile of a hysteresis curve, of the magnetic lamination.

In some embodiments, the setpoint value for the physical variable comprises one or more geometric dimensions of the stack of magnetic laminations and/or one or more of the following physical variables: an overall density of the stack and/or a variance in geometric dimensions of the stack, e.g. transversely to the stacking direction, and/or one or more magnetic properties of the stack, in particular a magnetic saturation field strength and/or parameters of a hysteresis curve, e.g. a coercive field strength and/or a remanence, of the stack.

In some embodiments, the stacking sequence is ascertained for a genuine subset of the plurality of magnetic laminations. In this way, magnetic laminations which are not suitable generally, that is to say not just at a specific point of the candidate sequence, for the construction of the stack in terms of their measured physical properties can be excluded from the manufacture of the stack. It is furthermore also possible, alternatively or additionally, to utilize suitable magnetic laminations, for instance from earlier production batches. In some embodiments, certain portions of the candidate sequence can be ascertained and certain portions of the stack can be assembled by stacking the portions one on another.

In some embodiments, the stacking sequence is expediently ascertained by firstly determining at least two or more candidate stacking sequences for a stacking sequence and comparing actual values for the candidate stacking sequences with the setpoint value and ascertaining as stacking sequence that candidate stacking sequence that has an actual value deviating the least from the setpoint value. In this respect, it is fundamentally possible to proceed according to a multiplicity of algorithms. As a result, for instance, firstly magnetic laminations of a candidate stacking sequence can be provided all the more closely to one another the more similar their physical properties are. In further approaches, a candidate sequence can firstly be optimized on its own in terms of a single physical property. Subsequently, the candidate stack can then be varied to an increasing extent until the actual value for the physical variable of the stack increasingly converges with the setpoint value for the physical variable.

In some embodiments, the stacking sequence is ascertained by means of artificial intelligence. For this, use may be made of a neural network which receives the measured, i.e. recorded, physical properties of the magnetic laminations as input data and includes the deviation of the actual value from the setpoint value as optimization criterion. The neural network is trained beforehand on the basis of a multiplicity of simulated physical properties of magnetic laminations or on the basis of a multiplicity of physical properties of actual magnetic laminations.

In some embodiments, a geometric shape of the stack is recorded and a geometric shape of a stacking aid, which makes it possible to stack the magnetic laminations in the ascertained stacking sequence, is ascertained. Expediently, the stacking aid has a form corresponding to the form of the magnetic laminations. In some embodiments, the stacking aid is used to stack magnetic laminations for a stator, wherein the magnetic laminations have a central leadthrough, in which teeth of the magnetic laminations protrude radially into the leadthrough, for the stator. Expediently, the stacking aid has a central cylindrical main body from which extend radial spokes corresponding to the interspaces between the teeth of the magnetic laminations. In this way, magnetic laminations can be pushed onto the stacking aid, with the result that the magnetic laminations can be oriented and positioned as anticipated to form the stator.

In some embodiments, adapting and/or exchanging elements for adapting the actual value to the setpoint value are provided and the stacking sequence is ascertained taking into account the adapting and/or exchanging elements in such a way that firstly, a deviation of an actual value for the physical variable of the stack with the ascertained stacking sequence from the at least one setpoint value is reduced by means of the adapting and/or exchanging elements. In some embodiments, firstly an initial stacking sequence is ascertained and then the adapting and/or exchanging elements are provided. After that, a final stacking sequence is then ascertained for manufacture.

In some embodiments, the adapting and/or exchanging elements are manufactured by additive manufacturing processes. Expediently, the additive manufacture comprises selective laser melting and/or laser metal deposition and/or wire arc additive manufacturing and/or fused deposition modeling and/or stereolithography and/or screen and/or stencil printing and/or spraying and/or slip casting processes and/or tape casting. In some embodiments, the adapting and/or exchanging elements are manufactured with, ideally from, metal and/or materials of the magnetic lamination.

In some embodiments, the stacking aid is manufactured by additive manufacturing and the stack is formed by means of the stacking aid. In some embodiments, the additive manufacture here comprises selective laser melting and/or laser metal deposition and/or wire arc additive manufacturing and/or fused deposition modeling and/or stereolithography and/or screen and/or stencil printing and/or spraying and/or slip casting processes and/or tape casting.

In some embodiments, the magnetic laminations are stacked and pressed together, that is to say firstly the magnetic laminations are all stacked or subsets of the magnetic laminations each comprising three or more magnetic laminations are all stacked and then jointly pressed together as a composite.

In some embodiments, the magnetic laminations can be alternately stacked and pressed together, that is to say a respective magnetic lamination is added to the stack and pressed together with the rest of the stack.

In some embodiments, a rotor and/or a stator are or is formed with a stack of magnetic laminations, wherein the stack of magnetic laminations is manufactured by a method for manufacturing a stack of magnetic laminations for a rotor and/or stator of an electric machine as described above. In this way, an electric machine with a predefined specification can be manufactured also by means of new manufacturing techniques, such as in particular screen and/or stencil printing.

In some embodiments, firstly an electric machine is manufactured by a method for manufacturing an electric machine as claimed in the preceding claim and then the installation or the vehicle is provided with the electric machine. Expediently, the electric machine is provided, i.e. disposed, in a drive unit of the installation and/or of the vehicle. The methods described herein makes it possible also to produce an installation and/or a vehicle having engines manufactured by means of new manufacturing techniques, such as in particular screen and/or stencil printing.

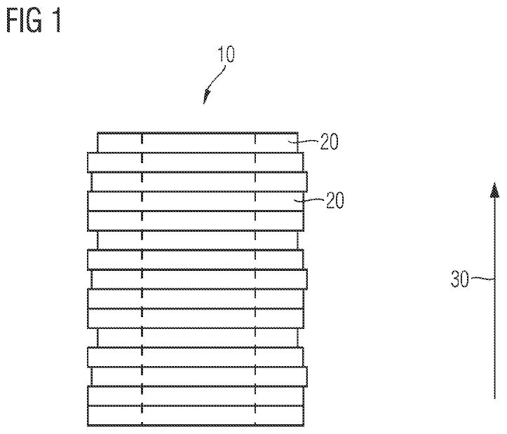

The stack 10 of magnetic laminations 20 that is illustrated in FIG. 1 forms a stator of an electric machine. The statements made in this description relating to the stator correspondingly also apply to a rotor of the electric machine. The magnetic laminations 20 of the stack 10 are screen-printed parts manufactured by means of a screen and/or stencil printing technology. To that end, the magnetic laminations 20 of the stack 10 are manufactured by means of printing a metal paste and then sintering.

As screen-printed parts, the magnetic laminations 20 of the stack 10 exhibit considerable variation in terms of their physical properties. In particular, the geometric dimensions of the magnetic laminations 20 vary owing to a sintering shrinkage which cannot be fully controlled. For example, the outside diameter of the magnetic laminations 20 varies, as is shown in greatly exaggerated fashion in FIG. 1. Further physical properties of the magnetic laminations 20 which vary from one manufactured magnetic lamination 20 to the next manufactured magnetic lamination 20 are the density of the magnetic laminations 20, a microstructure and a chemical composition and a topography and a heat conductivity and mechanical internal stresses of the magnetic laminations 20.

In addition, the magnetic properties of the magnetic laminations 20 vary from one magnetic lamination 20 to the next magnetic lamination 20. In the exemplary embodiment shown, a saturation field strength and a coercive field strength and a hysteresis, for example the profile of a hysteresis curve, of the magnetic laminations 20 vary.

The magnetic laminations 20 are stacked in a stacking direction 30 to form the stack 10. For the purpose of constructing the stack 10, a resulting degree of freedom firstly is a sequence of the magnetic laminations 20 along the stacking direction 30 one on another. Secondly, in the exemplary embodiment shown, the quantity of magnetic laminations 20 available for the stacking to form the stack 10 comprises a greater number of magnetic laminations 20 than the number of magnetic laminations 20 required for the construction of the stator. It is thus possible to select magnetic laminations 20 from the available quantity of magnetic laminations 20 to construct the stack 10.

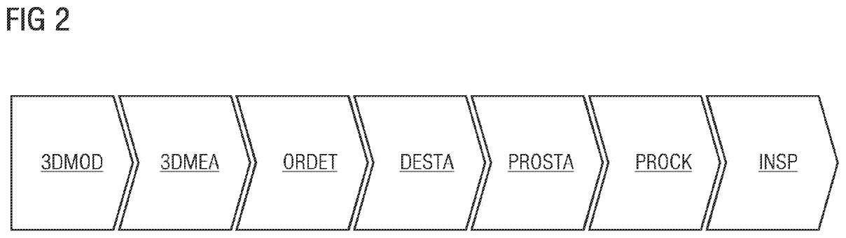

FIG. 2 shows an example method incorporating teachings of the present disclosure for manufacturing the stack 10 in detail.

Firstly, a model of a stack of ideal, i.e. simulated or modeled, magnetic laminations, which forms a setpoint construction of the stack for forming the stator, is generated 3DMOD by means of modeling software running on a computer. By means of the modeling software, a physical variable of the stack is determined as setpoint value from the setpoint construction of the stack. In the exemplary embodiment shown, the physical variable of the stack comprises an overall density of the stack 10 and a variance in geometric dimensions of the stack 10 transversely to the stacking direction 30 and magnetic properties of the stack 10, here a magnetic saturation field strength and parameters of a hysteresis curve, specifically a coercive field strength and a remanence. The physical variable is thus present in the form of a vector, i.e. the setpoint variable is a vector of multiple physical variables and the setpoint value is a vectorial variable.

In addition, all the magnetic laminations 20 available for a construction of the stack 10 are measured 3DMEA. On the basis of an optical measurement by means of a camera, the outer geometry of the magnetic laminations 20, i.e. their geometric dimensions, is measured individually by means of image recognition. Using a heat source and a temperature sensor, for instance a thermal imaging camera, the heat conductivity of each magnetic lamination 20 is individually measured. In addition, the density of the individual magnetic laminations 20 is measured by weighing the individual magnetic laminations 20 and determining the volume of the magnetic laminations on the basis of the geometric dimensions. In some embodiments, the volume of the magnetic laminations can also be determined individually on the basis of fluid displacement. Each individual magnetic lamination 20 is also measured in terms of the magnetic properties, here the magnetic saturation field strength and a coercive field strength, of the magnetic laminations 20 by subjecting the magnetic laminations 20 to a magnetic field and measuring the profile of a hysteresis curve of each magnetic lamination 20.

In addition, the topography of the magnetic laminations 20 and the chemical composition and the microstructure of the magnetic laminations 20 are measured on the basis of light- and/or electron-optical scanning and scattering measurements. In the process, it is possible to determine the chemical composition and to identify the microstructure of the magnetic laminations 20 by means of artificial intelligence by using a neural network trained on the basis of image data of magnetic laminations of which the chemical composition and microstructure are known. Mechanical internal stresses of the magnetic laminations 20 are also ascertained by means of digital image correlation, wherein it is alternatively or additionally also possible to use other known methods for ascertaining internal stresses.

Then, candidate stacks with multiple sequences of the actually present magnetic laminations 20 of the plurality are predetermined as candidate sequences. For the multiple candidate sequences, the resulting physical variables of the candidate stack are simulated as actual values by the modeling software on the basis of the measured physical properties. That candidate stack of which the physical variable has the smallest possible deviation from the setpoint value for the setpoint construction of the stack 10 is selected ORDET. Since the physical variable is a vectorial variable, a deviation by means of a suitable amount of distance between the vectorial variables, that is to say from the setpoint value and from the actual value in each case, from one another is ascertained, for instance a sum of the squares of the differences between the individual values of the vectorial variables or a sum of the magnitudes of the differences between the individual values of the vectorial variables. After the candidate stack with the smallest deviation of the actual value from the setpoint value has been selected ORDET, the candidate stacking sequence is established DESTA as stacking sequence of the stack 10.

In some embodiments, which are not illustrated separately and in all other respects correspond to the exemplary embodiment illustrated, the stacking sequence is ascertained for a genuine subset of the plurality of magnetic laminations. In this way, magnetic laminations 20 which are not suitable generally, that is to say not just at a specific point of the candidate sequence, for the construction of the stack 10 in terms of their measured physical properties can be excluded from the manufacture of the stack 10. These magnetic laminations 20 then form rejects.

In some embodiments, which are not illustrated separately and in all other respects correspond to the exemplary embodiment illustrated, the candidate sequences are ascertained by means of artificial intelligence. For this, use is made of a neural network (not illustrated in the drawing) which receives the measured physical properties of the magnetic laminations 20 as input data and implements the deviation of the actual value from the setpoint value as optimization criterion. The neural network is trained beforehand on the basis of a multiplicity of simulated physical properties of magnetic laminations 20. To that end, in the exemplary embodiment shown, a stacking aid 50, by means of which the magnetic laminations 20 can be stacked to form the selected candidate stack, is manufactured PROSTA.

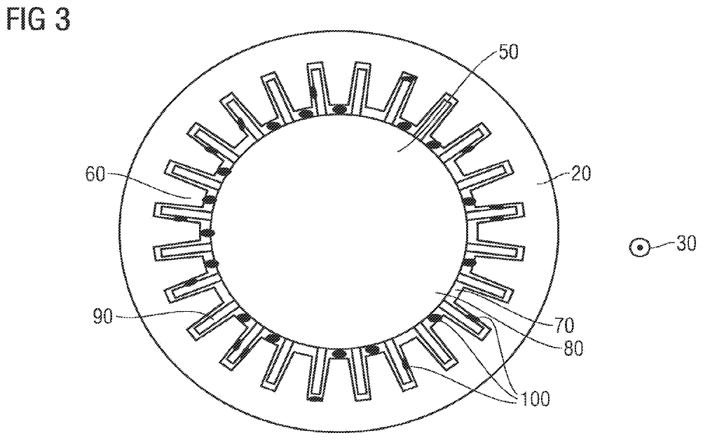

The form of the stacking aid 50 is adapted to the form of the magnetic laminations 20. The stacking aid and the magnetic laminations 20 are shown in more detail in FIG. 3:

In the plane transverse to the stacking direction 30, the magnetic laminations 20 have the shape of a circular ring, from which teeth 60 extend radially inward in the direction of a center point of the circular ring. Here, the teeth 60 end radially inward on an imaginary circle which concentrically surrounds the center point of the circular ring. The teeth 60 thus end at a central leadthrough 70, in which a rotor of the electric machine can be disposed.

The stacking aid 50 has a shape corresponding to this, with the result that the stacking aid 50 can be guided through the leadthrough 70 of the magnetic lamination 20. The stacking aid 50 has a cylindrical main body 80 from which spokes 90 extend radially outward and perpendicularly in relation to a longitudinal center axis which forms the axis of symmetry of the cylindrical main body. The spokes 90 correspond to interspaces between the teeth 60 of the magnetic laminations 20, with the result that the spokes 90 can be disposed between the teeth 60. In this case, the spokes 90 have such small circumferential dimensions that the spokes 90 can be disposed between the teeth 60 of each magnetic lamination in spite of individual deviations owing to manufacturing tolerances. Since the selected candidate stack does not comprise idealized magnetic laminations, but rather specifically measured magnetic laminations 20, the magnetic laminations 20 have geometric deviations from one another caused by manufacturing tolerances. The magnetic laminations 20 provided in the candidate sequence of the selected candidate stack can then be fixed in terms of position and alignment in the candidate stack in this way by adapting the stacking aid 50 to the individual form of the magnetic lamination 20 in that portion at which the magnetic lamination 20 is provided. This can, for instance, also be effected by additively manufactured molded-on formations 100, for instance in the form of suitably dimensioned webs, which at least also extend in the stacking direction 30 and in each case preferably continuously widen or taper along the stacking direction 30, on the spokes 90, for instance in the radial and/or circumferential direction, or by way of molded-on formations 100 on a cylindrical lateral surface of the cylindrical main body 80. Such molded-on formations 100 on the spokes 90 or on the cylindrical lateral surface can be applied to a stacking aid by means of additive manufacturing processes. Therefore, the stacking aid 50 is adapted to the selected candidate sequence in customized fashion owing to the molded-on formations 100. In principle, the molded-on formations 100 of the stacking aid 50 may be manufactured by means of additive manufacturing, for instance selective laser melting and/or laser metal deposition and/or wire arc additive manufacturing and/or fused deposition modeling and/or stereolithography and/or screen and/or stencil printing and/or spraying and/or slip casting processes and/or tape casting. Ideally, the molded-on formations 100 are manufactured with, ideally from, metal and/or materials of the magnetic laminations 20.

In some embodiments, which are not illustrated separately and in all other respects correspond to the exemplary embodiment illustrated, the stacking aid 50 is not manufactured as new for this purpose, but rather use is made of a stacking aid 50 which is already provided with molded-on formations 100 and has already been used in earlier embodiments of the method incorporating teachings of the present disclosure. The adaptation is then effected in these exemplary embodiments such that the molded-on formations 100, insofar as they are dispensable for the current candidate sequence, are subtractively removed or made smaller in terms of their dimension and, insofar as new molded-on formations 100 are required, they are disposed additively on the stacking aid 50.

By means of the stacking aid 50, then the stack 10 with magnetic laminations 20 is stacked PROCK and subsequently the magnetic laminations 20 of the stack 10 are pressed together and then potted by means of pressing dies, which exert force on the stack 10 directed parallel to the stacking direction 30 and onto the stack 10. Therefore, the stack 10 of magnetic laminations 20 is connected, in non-readily detachable fashion, to form a composite of magnetic laminations 20.

In some embodiments, which are not illustrated separately and in all other respects correspond to the exemplary embodiment illustrated, the stack 10 of magnetic laminations is constructed without a stacking aid 50 by a respective magnetic lamination 20 being placed onto the stack 10, which was finished up to now, in the stacking direction 30 and being pressed together with the rest of the stack 10. All magnetic laminations 20 of the stack 10 are then proceeded with until the stack 10 is finished. Then, the stack 10 is potted.

Lastly, the stack 10 with magnetic laminations 20 is subjected to an inspection INSP. During the inspection INSP, the setpoint variable, that is to say the vector of the multiple physical variables, of the constructed stack 10 is measured, that is to say the overall density of the stack 10 and the variance in geometric dimensions of the stack 10 transversely to the stacking direction 30 and magnetic properties of the stack 10, here the magnetic saturation field strength and parameters of a hysteresis curve, specifically the coercive field strength and the remanence, are measured.

When the setpoint variable of the constructed stack 10 deviates less from the previously defined setpoint value than there is correspondence with a previously established tolerance, the stack 10 is considered suitable for the construction of a stator 510.

In some embodiments, which are not illustrated separately and in all other respects correspond to the exemplary embodiment described above, when the setpoint variable deviates more strongly than there is correspondence with the tolerance, a digital simulation is used to test whether retrospective manufacture of individual ones or less, for instance at most 5%, of the magnetic laminations 20 and the exchange of the corresponding magnetic laminations 20 of the stack 10 could lead to a smaller deviation of the stack 10. If this is the case, the magnetic laminations 20 are correspondingly exchanged, before they are pressed together and potted and the stack 10 is formed with the exchanged magnetic laminations 20. In some embodiments, the candidate stacking sequence thus ascertained of the stack 10 can in addition be optimized further, before the stack 10 is ultimately formed. The exchanged magnetic laminations can be manufactured by means of additive manufacture, for instance by means of additive manufacture such as in particular selective laser melting and/or laser metal deposition and/or wire arc additive manufacturing and/or screen and/or stencil printing and/or spraying and/or slip casting processes and/or tape casting. Ideally, the exchanged magnetic laminations are manufactured with, ideally from, metal and/or materials of the rest of the magnetic laminations 20.

In some embodiments, which are not illustrated separately and in all other respects correspond to the exemplary embodiment described above, for further optimization, i.e. to converge the setpoint variable with the setpoint value, a digital simulation is used to test whether additive molded-on formations on individual magnetic laminations 20 lead to an improvement in the stack 10. In these exemplary embodiments, before the stack 10 is constructed in the candidate sequence, digital simulation is used to check whether additive molded-on formations on individual ones, for instance at most 5%, of the magnetic laminations 20 would lead to the actual value for the digital simulation of the stack 10 converging with the setpoint value. If such a convergence is established, the magnetic laminations 20 are each provided with such molded-on formations by means of additive manufacture, for instance by means of laser deposition welding, and the stack 10 is then formed. In principle, the candidate sequence of the magnetic laminations 20 with the provided molded-on formations can be further optimized, such that an even better candidate sequence can be found.

The molded-on formations on the magnetic laminations 20 can be manufactured by additive manufacturing, for instance selective laser melting and/or laser metal deposition and/or wire arc additive manufacturing and/or screen and/or stencil printing and/or spraying and/or slip casting processes and/or tape casting. Ideally, the molded-on formations are manufactured with, ideally from, metal and/or materials of the magnetic laminations 20.

To construct the stator 510, the stack 10 is provided in a manner known per se with electrical coils (not explicitly illustrated in the drawing) for building up a magnetic stator field, by winding these coils around the teeth 60 of the magnetic laminations 20 of the stack 10.

In the stator 510 constructed in this way, a rotor 500 manufactured by means of the method according to the invention for manufacturing a stack of magnetic laminations is introduced in a manner known per se, with the result that the stator 510 and the rotor 500 together form an electric motor 520.

The motor 520 is installed in a drive device 530 of an installation 540 or an electric vehicle in a manner known per se.

What is claimed is:

1. A method for manufacturing a stack of magnetic laminations for a rotor and/or stator of an electric machine, the method comprising:
recording
a respective physical property of each respective magnetic lamination from a plurality of magnetic laminations;
determining a setpoint value for a physical variable of the stack of magnetic laminations;
ascertaining a stacking sequence of the individual magnetic laminations of the plurality reducing a deviation of an actual value for the physical variable of the stack with the ascertained stacking sequence from a setpoint value in relation to stacks with other stacking sequences of magnetic laminations; and
stacking the plurality of the magnetic laminations in the ascertained stacking sequence.

2. The method as claimed in claim 1, further comprising manufacturing the plurality of magnetic laminations using screen and/or stencil printing.

3. The method as claimed in claim 1, wherein the respective physical property comprises one or more of: a geometric dimensions of the magnetic lamination, a density of the magnetic lamination, a microstructure, chemical composition, a topography, a heat conductivity, one or more mechanical internal stresses of the magnetic lamination, one or more magnetic properties of the magnetic lamination, a saturation field strength, a coercive field strength, a remanence, a hysteresis.

4. The method as claimed in claim 1, wherein the setpoint value for the physical variable comprises one or more of: geometric dimensions of the stack of magnetic laminations, an overall density of the stack, a variance in geometric dimensions of the stack, one or more magnetic properties of the stack, a magnetic saturation field strength, parameters of a hysteresis curve, a coercive field strength, or a remanence.

5. The method as claimed in claim 1, wherein the stacking sequence is ascertained for a genuine subset of the plurality of magnetic laminations.

6. The method as claimed in claim 1, wherein ascertaining the stacking sequence includes firstly determining at least two or more candidate stacking sequences for a stacking sequence and comparing actual values for the candidate stacking sequences with the setpoint value and ascertaining as stacking sequence that candidate stacking sequence that has an actual value deviating the least from the setpoint value.

7. The method as claimed in claim 1, wherein the stacking sequence is ascertained using artificial intelligence.

8. The method as claimed in claim 1, further comprising:
recording a geometric shape of the stack; and
ascertaining a geometric shape of a stacking aid which makes it possible to stack the magnetic laminations in the ascertained stacking sequence.

9. The method as claimed in claim 1, further comprising:
adapting and/or exchanging elements for adapting the actual value to the setpoint value;
the stacking sequence is ascertained taking into account the adapting and/or exchanging elements in such a way that a deviation of an actual value for the physical variable of the stack with the ascertained stacking sequence from the at least one setpoint value is reduced by means of the adapting and/or exchanging elements.

10. The method as claimed in claim 1, wherein the adapting and/or exchanging elements are manufactured using additive manufacturing.

11. The method as claimed in claim 1, wherein the stacking aid is manufactured by additive manufacturing processes and the stack is formed by means of the stacking aid.

12. The method as claimed in claim 1, wherein the magnetic laminations are stacked and pressed together.

13. The method as claimed in claim 1, wherein the magnetic laminations are alternately stacked and pressed together.

14. A method for manufacturing an electric machine, the method comprising:
forming a rotor and/or a stator with a stack of magnetic laminations;
wherein the stack of magnetic laminations is manufactured by a method for according to claim 1.

15. (canceled)
